(19) United States
(12) Patent Application Publication
(10) Pub. No.: US 2025/0303659 A1
(43) Pub. Date: Oct. 2, 2025

(54) PRECURED TIRE TREAD HAVING VARIABLE PITCH SEQUENCE

(71) Applicant: Bridgestone Americas Tire Operations, LLC, Nashville, TN (US)

(72) Inventor: Jon I. Stuckey, Uniontown, OH (US)

(21) Appl. No.: 18/865,159

(22) PCT Filed: Apr. 28, 2023
(86) PCT No.: PCT/US2023/066334

§ 371 Date: Nov. 12, 2024

Related U.S. Application Data
(60) Provisional application No. 63/347,048, filed on May 31, 2022.

(51) Int. Cl. B29D 30/56; B29D 30/58; B60C 11/03

(52) U.S. Cl. CPC B29D 30/56; B29D 30/58; B60C 11/0318

(57) ABSTRACT

A precured tire tread includes a first end and a second end, defining a length greater than 10 feet (300 cm). The precured tire tread further includes a top surface having a plurality of tread elements that define a tread pattern with a pitch sequence of at least two sizes, including primary pitches having a first pitch size and secondary pitches having a second pitch size. The pitch sequence includes a pattern of primary pitches and secondary pitches that is repeated at least once along the length of the precured tire tread. The precured tire tread has the first pitch size at the first end and the second pitch size at the second end.

### FIELD OF INVENTION

The present disclosure relates to the field of tire retreading and precured tire treads. More particularly, the present disclosure relates to the field of tire retreading and precured tire treads having a variable pitch sequence.

### BACKGROUND

Retreading of a tire may include removing a worn tread from a tire casing by a buffing process. A molded, precured tire tread is cut to an appropriate length so that it can be wound about the tire casing with a first end abutting a second end. An adhesive is applied to the tire casing, the precured tire tread, or both the tire casing and the precured tire tread.

Such retreading processes may be applied to tires for large trucks and busses. Known precured tire treads for large trucks and busses have a single pitch size. Such treads are known as a mono-pitch or single sided application. When a mono-pitch is employed, an operator may cut a long, precured tire tread into one or more segments of desired length. Each segment may be wrapped around a tire casing, such that the first end of the segment abuts the second end of the segment. Because the segment has a single pitch size, the retreaded tire has a consistent tread pattern along its circumference, including at the location where the first end of the segment abuts the second end of the segment. Mono-pitch treads, however, are known to produce a tonal noise frequency that may be undesirable. Mono-pitch treads may be particularly undesirable in residential areas or in business communities.

Therefore, it is desirable to provide a precured tire tread having a variable pitch sequence. Such a precured tire tread may be useful for large trucks and busses, and may be particularly useful for vehicles that are predominantly driven in residential or commercial areas, rather than on highways or freeways. Such vehicles may include light trucks and passenger vehicles, and may also include commercial vehicles, such as commercial vans for last mile deliveries.

### SUMMARY OF THE INVENTION

In one embodiment, a method of retreading a tire includes providing a first tire casing having a first circumference and providing a first precured tire tread having a first end and a second end. The first precured tire tread has a total length greater than the first circumference, and the first precured tire tread has a tread pattern with a pitch sequence of at least two sizes, including a first pitch size and a second pitch size. The method further includes cutting the first precured tire tread into at least two sections, including a full section and a remaining section. The full section has a length equal to the first circumference of the first tire casing. The remaining section includes the second end of the first pre-cured tire tread, and the remaining section has a length less than the first circumference of the first tire casing. The method also includes wrapping the full section of the first precured tire tread around the first tire casing such that a first end of the full section abuts a second end of the full section.

In another embodiment, a precured tire tread includes a first end and a second end, defining a length greater than 10 feet (300 cm). The precured tire tread further includes a top surface having a plurality of tread elements that define a tread pattern with a pitch sequence of at least two sizes, including primary pitches having a first pitch size and secondary pitches having a second pitch size. The pitch sequence includes a pattern of primary pitches and secondary pitches that is repeated at least once along the length of the precured tire tread. The precured tire tread has the first pitch size at the first end and the second pitch size at the second end.

In yet another embodiment, a method of making a precured tire tread includes providing a tire casing having a tire casing circumference, and providing a first precured tire tread segment having a first end and a second end. The first precured tire tread segment has a first length less than the tire casing circumference, and the first precured tire tread segment has a tread pattern with a pitch sequence of at least two sizes, including a first pitch size and a second pitch size. The method further includes providing a second precured tire tread segment having a first end and a second end. The second precured tire tread segment has a second length less than the tire casing circumference, wherein the first length and the second length are equal to the tire casing circumference. The second precured tire tread segment has a tread pattern with a pitch sequence of at least two sizes, including the first pitch size and the second pitch size.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a schematic drawing of an exemplary mixing device for producing a green rubber mixture,

FIG. 2 is a schematic drawing of an exemplary extruding device for extruding a green tire tread strip,

FIG. 3 is a schematic drawing of an exemplary tire tread vulcanization mold,

FIG. 4 is a perspective view of one embodiment of roll of precured tire tread,

FIG. 5A is a schematic drawing of a side view of one embodiment of a precured tire tread being applied to a tire casing,

FIG. 5B is a schematic drawing of a side view of an alternative embodiment of a plurality of precured tire tread segments being applied to a tire casing, and

FIG. 6 is a schematic drawing of exemplary base sequences of tread patterns.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Tread” as used herein, refers to that portion of the tire that comes into contact with the road or ground under normal inflation and load.

While similar terms used in the following descriptions describe common tire components, it should be understood that because the terms carry slightly different connotations, one of ordinary skill in the art would not consider any one of the following terms to be purely interchangeable with another term used to describe a common tire component.

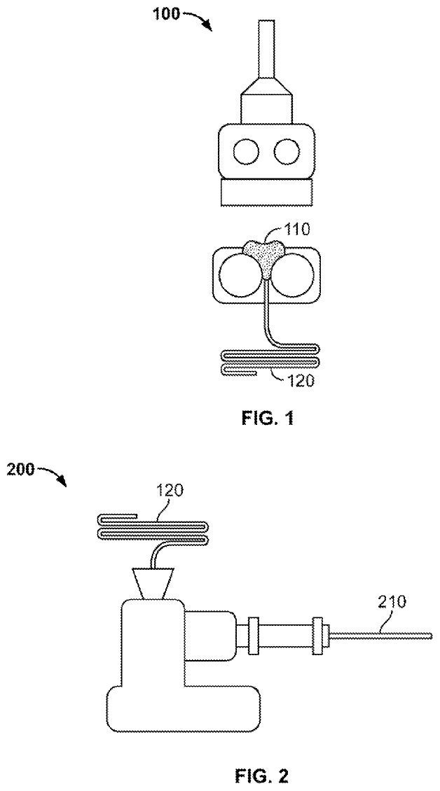

FIG. 1-3 are schematic illustrations of different stations in a system for preparing a precured tire tread in an exemplary system. These stations are merely exemplary and are provided for additional background. They are not intended to be limiting.

FIG. 1 is a schematic drawing of an exemplary mixing device 100 for receiving one or more compounds 110. The mixing device 100 mixes the one or more compounds 110 to produce a green rubber mixture 120. The details of mixing devices are known in the art and are not repeated here.

The green rubber mixture 120 is fed into an extruding device, such as the exemplary extruding device 200 shown schematically in FIG. 2. The extruding device 200 extrudes the green rubber mixture 120 into a continuous green strip 210 that is cut to the appropriate size for preparing the cured tire tread, and thus may be referred to as a green tire tread strip. The green tire tread strip has a first end and a second end. The details of extruding devices are known in the art and are not repeated here.

In the illustrated embodiment, the mixing device 100 and the extruding device 200 are shown as separate machines. In an alternative embodiment (not shown), a single machine may function as both a mixing device and an extruding device.

In an alternative embodiment, the green tire tread strip may be formed by a 3D printing or additive manufacturing process. In such an embodiment, the mixing device and extruding device may be omitted.

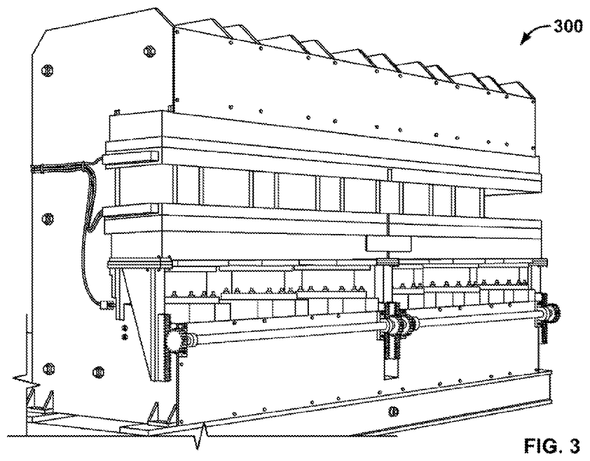

The green tire tread strip is placed in a tread vulcanization mold, such as the exemplary tire tread vulcanization mold 300 illustrated in FIG. 3. The green tire tread strip may be cut to an appropriate length according to the dimensions of the tread vulcanization mold 300. In one known embodiment, the green tire tread strip is cut to a length of approximately 30 feet (9 meters). In another known embodiment, the green tire tread strip is cut to a length greater than 30 feet (9 meters). For example, the green tread strip may be cut to a length of 34 feet (10 meters). In other known embodiments, the green tire tread strip is cut to a length of less than 30 feet (9 meters). For example, the green tire tread strip may be cut to a length between 6 to 10 feet (2 to 3 meters). As another example, the green tire tread strip may be cut to a length greater than 10 feet (3 meters). It should be understood, however, that the green tire tread strip may be cut to any desired length.

The tire tread vulcanization mold 300 cures the green tire tread strip by applying heat and pressure, thereby forming a precured tire tread having a first end and a second end. In one embodiment, the tire tread vulcanization mold 300 applies heat of about 350° F. (180° C.) with pressures of about 350 PSI (2400 kPa). In alternative embodiments, the tire tread vulcanization mold 300 applies heat of about 300-370° F. (150-190° C.) with pressures of about 200-850 PSI (1370-5800 kPa). The details of tire tread vulcanization molds are known in the art and are not repeated here.

Alternatively, the precured tire tread may be formed by a 3D printing or additive manufacturing process. In such an embodiment, although the step of curing a green tire tread strip in a tire tread vulcanization mold would be omitted, the resulting tire tread may still be referred to as “pre-cured,” because it has physical properties similar to that of a tire tread that has been cured in a tire tread vulcanization mold, or because a full curing process is unnecessary.

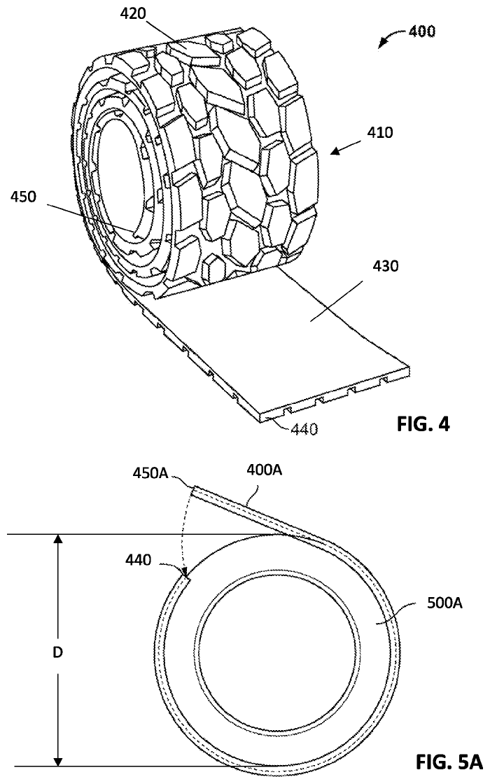

FIG. 4 is a schematic drawing of one embodiment of a precured tire tread 400. The precured tire tread 400 has substantially the same length as the green tire tread strip. In one known embodiment, the precured tire tread 400 has a length of approximately 30 feet (9 meters). In another known embodiment, the precured tire tread 400 has a length greater than 30 feet (9 meters). For example, the precured tire tread 400 has a length of 34 feet (10 meters). In other known embodiments, the precured tire tread 400 has a length of less than 30 feet (9 meters). For example, the precured tire tread 400 has a length between 6 to 10 feet (2 to 3 meters). As another example, the precured tire tread 400 has a length greater than 10 feet (3 meters). However, it should be understood that the precured tire tread 400 may have any desired length.

The precured tire tread 400 includes a top surface 410 having a plurality of tread elements 420 thereon. In the illustrated example, the tread elements are a plurality of lugs separated by a plurality of grooves. In alternative embodiments, the tread elements may include ribs, bars, and blocks as well as additional grooves, sipes, and other tread elements.

The precured tire tread 400 also includes a bottom surface 430, a first end 440, and a second end 450. While the example precured tire tread 400 is shown as having a generally rectangular cross-section, it should be understood that the cross-section may be generally trapezoidal or include any number of straight or curved surfaces.

In one embodiment, the precured tire tread 400 is rolled in the manner shown in FIG. 4, such that the first end 440 is exposed. As one of ordinary skill in the art would understand, in some instances it may be easier to transport a rolled precured tire tread than a flat precured tire tread. In other instances, it may be preferable to leave the precured tire tread in a flat formation.

The tread elements 420 define a tread pattern with a pitch sequence of at least two sizes, including primary pitches having a first pitch size and secondary pitches having a second pitch size. In alternative embodiments, the pitch sequences includes at least three sizes, including primary pitches having a first pitch size, secondary pitches having a second pitch size, and tertiary pitches having a third pitch size. For example, it is known to have pitch sequences with three to five distinct pitch sizes.

The pitch sequence includes a pattern of primary pitches and secondary pitches. The pattern may be referred to as a base sequence, and is repeated at least once along the length of the precured tire tread. In one embodiment, the base sequence has the first pitch size at a first end and the second pitch size at a second end. Likewise, the precured tire tread 400 may have the first pitch size at the first end 440 and the second pitch size at the second end 450.

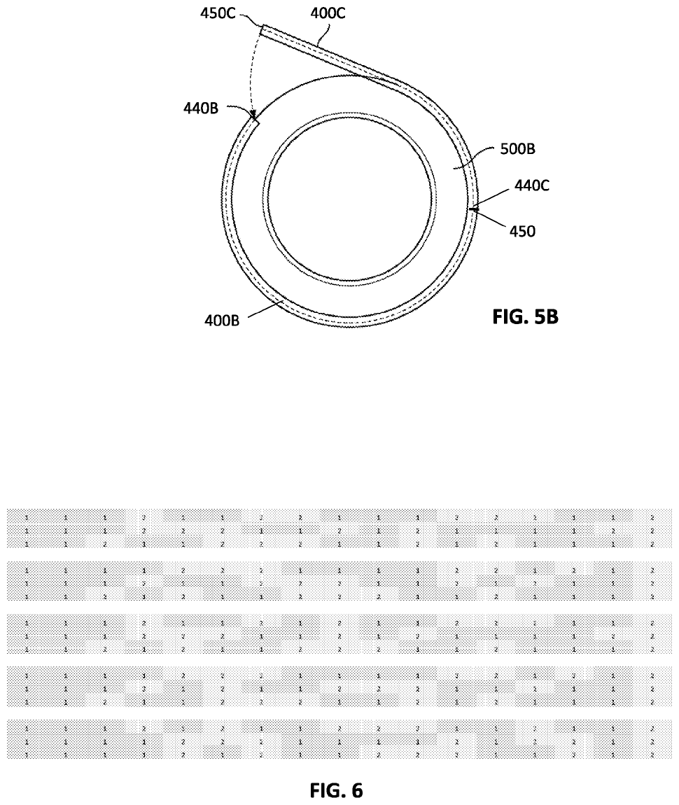

The precured tire tread 400 may be used in a retreading process. FIG. 5A illustrates a side view of a first tire casing 500A receiving a portion of the precured tire tread 400. In one embodiment, the first tire casing 500A has an existing tread that is partially worn. In such cases, the existing tread may first be buffed to a desired height before a precured tire tread is applied to the casing.

The first tire casing 500A has a diameter D, and thus has a circumference of AD. In one embodiment, the length of the precured tire tread 400 is greater than the tire casing circumference. For example, the tire casing circumference may be between 60 and 175 inches (150 to 440 cm). As another example, the tire casing circumference may be between 75 and 125 inches (190 to 320 cm).

In one embodiment, the pattern of primary pitches and secondary pitches (i.e., the base sequence) in the precured tire tread has a length that is less than the tire casing circumference. In an alternative embodiment, the pattern of primary pitches and secondary pitches in the precured tire tread has a length that is equal to the tire casing circumference.

Because the length of the precured tire tread 400 is greater than the tire casing circumference, the operator cuts the precured tire tread 400 into at least two sections. The two sections include a first full section 400A, having a length equal to the tire casing circumference. The first full section includes the first end 440 of the precured tire tread 400.

In some embodiments, the precured tire tread 400 is cut into a plurality of full sections, with each full section having a length equal to the tire casing circumference. In some embodiments, after one or more full sections have been cut from the precured tire tread 400, there will be a remaining section 400B that has a length less than the tire casing circumference. The remaining section 400B includes the second end 450 of the first precured tire tread 400.

In one embodiment, the retreading process includes applying a thin amount of uncured rubber between the first tire casing 500A and the precured tire tread 400. The assembly is then surrounded with a bag the tire and a vacuum force is applied while the assembly is cured.

In an alternative embodiment, the retreading process includes applying an adhesive to the first tire casing 500A, the bottom surface 430 of the first full section 400A of the precured tire tread 400, or to both the first tire casing 500A and the bottom surface 430 of the first full section 400A of the precured tire tread 400. Exemplary adhesives include, without limitation, materials with compositions based on elastomers such as natural or synthetic rubbers or blends of such polymers. In addition, the adhesives may be based on materials such as urethanes, epoxies, and acrylates. Further, the adhesives may be based on the curatives or activating agents of the above. After the adhesive is applied, it may be covered by a polymeric film. Exemplary polymeric films include, without limitation, polyethylene and polypropylene films.

In an alternative embodiment, the retread process includes applying a cement to the first tire casing 500A, the bottom surface 430 of the first full section 400A of the precured tire tread 400, or to both the first tire casing 500A and the bottom surface 430 of the first full section 400A of the precured tire tread 400. The cement may be to maintain contact of the components of the composite tire prior to curing. After the cement is applied, it may be covered by a polymeric film. Exemplary polymeric films include, without limitation, polyethylene and polypropylene films.

Cements may use solvent or water as the dispersing phase for the cement materials. The solvent based cement is comprised of a specialized rubber compound that may be dissolved or suspended in an organic solvent. The water based cements may be comprised of emulsified or suspended polymers combined with suspensions or emulsions of additives.

In the case where a cement or adhesive is applied to both the first tire casing 500A and the bottom surface 430 of the first full section 400A of the precured tire tread 400, the same cement or adhesive may be applied to both surfaces. Alternatively, a different cement or adhesive may be applied to each surface. For example, a first cement may be applied to the first tire casing 500A and a second cement both having properties that cause them to remain in contact with the uncured rubber adhesive. Once the tire composite is assembled (using the cemented components) the bonding may take place. Such bonding may begin or occur rapidly on contact, or with the application of temperature or pressure above a threshold amount.

In any of the above described embodiments, the process may also include applying a cement or adhesive to the first end 440 of the first full section 400A of the precured tire tread 400, the second end 450A of the first full section 400A of the precured tire tread 400, or both the front and second ends 440, 450A of the first full section 400A of the precured tire tread 400. Exemplary adhesives include, without limitation, materials based on elastomers, elastomeric blends, or other polymers with additives to enhance adhesion properties or provide other desirable properties. In one embodiment, a strip of green rubber may be employed as the adhesive. Where a cement is used, the cement may be one of the cements described above.

In the case where a cement or adhesive is applied to both the front and second ends 440, 450A of the first full section 400A of the precured tire tread 400, the same cement or adhesive may be applied to both surfaces. Alternatively, a different cement or adhesive may be applied to each surface. For example, a first cement may be applied to the first end 440 of the first full section 400A of the precured tire tread 400 and a second cement both having properties that cause them to remain in contact with the uncured rubber adhesive. Such bonding may begin or occur rapidly on contact, or with the application of temperature or pressure above a threshold amount.

The retreading process further includes wrapping the first full section 400A of the precured tire tread 400 circumferentially around the first tire casing 500A such that the first end 440 of the first full section 400A of the precured tire tread 400 abuts a second end 450A of the first full section 400A of the precured tire tread 400.

After the first full section 400A of the precured tire tread 400 has been wound circumferentially around the first tire casing 500A, the combined tire casing and precured tire tread may be cured in a pressure chamber (not shown). As one of ordinary skill in the art would understand, this curing process is typically done at relatively low temperatures and pressures, compared to the curing of a green tire. In one embodiment, the combined tire casing and precured tire tread is cured at a temperature of about 200° F. (100° C.) and a pressure of about 90 PSI (600 kPa). In other embodiments, the combined tire casing and precured tire tread is cured at a temperature between 200 to 300° F. (100 to 150° C.) and a pressure between 70 to 120 PSI (480 to 830 kPA). After the curing process, the cured tire is removed and may be used on a vehicle.

The process of applying a tire tread to a tire casing and curing the tire tread and tire casing assembly may be repeated for each full section of the precured tire tread 400. The remaining section 400B of the precured tire tread 400 may be applied to second tire casing 500B in the manner described below with reference to FIG. 5B.

FIG. 5B is a schematic drawing of a side view of an alternative embodiment of a plurality of precured tire tread segments being applied to a tire casing. In the illustrated embodiment, a second tire casing 500B is provided. In one embodiment, the second tire casing 500B has the same circumference as the first tire casing 500A. In an alternative embodiment, the second tire casing may be larger or smaller than the first tire casing.

A second precured tire tread (not shown) is also provided. The second precured tire tread has a first end and a second end. The second precured tire tread may be substantially the same as the first precured tire tread 400, and thus may have substantially the same length. In other words, the second precured tire tread has a total length greater than the tire casing circumference, and the second precured tire tread has a tread pattern with a pitch sequence of at least two sizes, including the first pitch size and the second pitch size. The second precured tire tread has the first pitch size at its first end and the second pitch size at its second end.

An operator cuts a complementary section 400C from the second precured tread. The complementary section 400C includes the first end of the second precured tire tread. The complementary section 400C has a length such that the sum of the lengths of the remaining section 400B and the complementary section 400C is equal to the circumference of the second tire casing 500B.

The operator may treat one or more of the second tire casing 500B, the remaining section 400B, and the complementary section 400C with an adhesive or cement, in the manner described above. The operator then wraps the remaining section 400B of the precured tire tread 400 around a portion of the second tire casing 500B. The operator abuts a first end 440C of the complementary section 400C to the second end 450 of the remaining section 400B, which is also the second end 450 of the first precured tire tread 400. The operator wraps the complementary section 400C around a portion of the second tire casing 500B such that a second end 450C of the complementary section 400C abuts a first end 440B of the remaining section 400B.

As previously noted, because the precured tire tread has a length that is less than the tire casing circumference, a segment of appropriate length must be cut from the precured tire tread. Unlike with a mono-pitch tread, however, a pattern that includes both primary pitches and secondary pitches in the resulting segment may have ends that are not compatible. For example, after the segment is wrapped around a tire casing, the resulting tire may exhibit an undesirable frequency modulation as the tire rotates-particularly when the transition between the first end and the second end rotates through the footprint of the tire. It has been found, however, that a variable pitch tread pattern may reduce or eliminate such undesirable frequency modulation if the tread pattern includes certain characteristics.

The precured tire tread length from a remaining roll will typically be longer than the circumferential length of the casing, so in most instances a single piece of precured tire tread is applied. However, on occasion we would expect two pieces from typically using the end of one roll and the beginning of another. The portion of the tire that is typically less than or equal to the casing length is the length of the base pitch sequence. Thus the resulting tire pitch sequence yields the base sequence plus an additional length, which may be referred to as alpha. So the number of repetitions of the Base Sequence on any given tire is greater than 1.0. In other words, the full base sequence is used on every tire.

While exemplary two-pitch sequences are described herein, it should be understood that these teachings could be applied to pitch sequences of more than two pitch sizes. For example, the technique described below could be applied to a pattern of 3 to 5 pitch sizes, or even more pitch sizes.

The exemplary tread patterns are described as having primary pitches and secondary pitches. It should be understood that these designations are arbitrary, and are merely used for identification purposes. In some of the examples in the specification, the primary pitches are described as shorter than the secondary pitches. Again, this designation is arbitrary. When the terms “primary pitches” and “secondary pitches” are used in the claims, they are not intended to convey a relative length of the pitches unless such lengths are expressly recited in the claims.

In one embodiment, the repeating tread pattern (i.e., the base sequence) has a length that is between 75% to 90% of the circumference of the tire casing. Thus, the resulting tire would include 100% of the base sequence with a supplemental section that is a portion of the base sequence (i.e., alpha). In an alternative embodiment, the base sequence has a length that is between 25% and 30% of the circumference of the tire casing. Thus, the resulting tire would include four full base sequences, or three full base sequences with a supplemental section that is a portion of a base sequence. It has been found that when such patterns are employed, the precured tire tread may be used on tires casings with different circumferences. While it may be desirable to produce a base sequence with a length equal to the circumference of the tire casing, such a tread may not be compatible with tire casings of different circumferences.

It should be understood that different precured treads may be preferable for different circumstances. For example, one precured tread may be optimized for Last Mile Delivery (i.e., delivery vans or trucks in a city, suburban, or rural setting), while another precured tire tread is optimized for highway driving by large trucks.

The tread pattern may be designed such that each of the patterns has a similar stiffness. This will reduce wear variability. For example the stiffness of the primary pitches may be between 90% to 110% of the stiffness of the secondary pitches. In one embodiment, some of the pitches include tread wear indicators. It may be desirable to include at least six tread wear indicators about the circumference of the tire.

In one embodiment, the long pitches have a length that is between 135-145% of the length of the short pitches. In other words, a ratio of the long pitch length to the short pitch length is between 1.35 and 1.45. In an alternative embodiment, the ratio of the long pitch length to the short pitch length is between 1.45 to 1.65.

It may be desirable for the total length of the long pitches to be approximately equal to the total length of the short pitches in a base sequence. In one embodiment, the short pitches define 40-60% of the pattern length and the long pitches define 40-60% of the pattern length. Using such parameters, one embodiment of a base sequence includes 30 short pitches for every 21 long pitches. Another embodiment of a base sequence includes 10 short pitches for every 7 long pitches.

It is desirable for the base sequence to include no more than three consecutive long pitches, and no more than four consecutive short pitches. Larger groupings of long pitches lead to a larger footprint stiffness and larger groupings of short pitches lead to a lower footprint stiffness, thus the pattern deflection in the stiff part of the tire can be measurably less than the soft part of the tire leading to axle vibrations and uneven wear. It is therefore desirable to limit the number of consecutive long pitches and short pitches to about half of a typical footprint length yielding the three long pitch and four short pitch limits. To avoid exceeding these desired limits, the base sequence may begin with a primary pitch and end with a secondary pitch. Likewise, the precured tire tread may have a primary pitch at a first end and a secondary pitch at a second end.

It is also desirable, however, to minimize alternating between long pitches and short pitches. Treads that frequently alternate between long pitches and short pitches will have low peak-to-peak modulation, which can also lead to undesirable first and second order modulation. Instead, it is desirable for each segment to have the same level of peak-to-peak modulation. In other words, it is desirable to have the widest range of frequencies with as even a distribution as possible. The lowest frequency in the tire will be at a section of the tread with the largest consecutive number of large elements and the highest frequency will be at a section of the tread with the smallest number of elements, so is desirable to maximize the frequency range and minimize the alternation between long pitches and short pitches as their frequency is constant and can be undesirable.

FIG. 6 is a schematic drawing of exemplary base sequences of tread patterns that have been found to exhibit desirable harmonics. In these schematics, the short pitches are designated by blocks labeled “1,” while the long pitches are designated by blocks labeled “2.” These designations are arbitrary. As can be seen in these drawings, each base sequence begins with a short pitch and ends with a long pitch. It should be understood that these base sequences may be reversed, such that they begin with a long pitch and end with a short pitch. As can also be seen in these drawings, each sequence includes a maximum of three consecutive long pitches and four consecutive short pitches.

The sequences shown in FIG. 6 were found to be sufficiently robust to result in very low first, second, and third order modulation and to have good spectral characteristics. In other words, the sequences improve sound quality and generate white noise.

The methods and constructions described in this disclosure may also allow for rubber savings. For example, the methods and constructions described herein may reduce the amount of scrap rubber that is produced during a tire retreading process.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A method of retreading a tire, the method comprising:
providing a first tire casing having a first circumference;
providing a first precured tire tread having a first end and a second end,
wherein the first precured tire tread has a total length greater than the first circumference, and
wherein the first precured tire tread has a tread pattern with a pitch sequence of at least two sizes, including a first pitch size and a second pitch size;
cutting the first precured tire tread into at least two sections, including a full section and a remaining section,
wherein the full section has a length equal to the first circumference of the first tire casing,
wherein the remaining section includes the second end of the first precured tire tread, and
wherein the remaining section has a length less than the first circumference of the first tire casing;
wrapping the full section of the first precured tire tread around the first tire casing such that a first end of the full section abuts a second end of the full section.

2. The method of claim 1, wherein the first precured tire tread has the first pitch size at the first end and the second pitch size at the second end.

3. The method of claim 1, further comprising providing a strip of green rubber between the first tire casing and the first precured tire tread.

4. The method of claim 1, wherein the cutting of the first precured tire tread into at least two sections includes cutting the first precured tire tread into at least three sections, including the full section, a second full section, and the remaining section.

5. The method of claim 1, further comprising:
providing a second tire casing having a second circumference;
providing a second precured tire tread having a first end and a second end,
wherein the second precured tire tread has a total length greater than the first circumference, and
wherein the second precured tire tread has a tread pattern with a pitch sequence of at least two sizes, including the first pitch size and the second pitch size;
cutting a complementary section from the second precured tire tread,
wherein the complementary section includes the first end of the second precured tire tread,
wherein the complementary section has a length less than the second circumference of the second tire casing, and
wherein a sum of the lengths of the remaining section and the complementary section is equal to the second circumference of the second tire casing;
wrapping the remaining section of the first precured tire tread around a portion of the second tire casing;
abutting a first end of the complementary section of the second precured tire tread to a second end of the remaining section of the first precured tire tread; and
wrapping the complementary section around a portion of the second tire casing such that a second end of the complementary section of the second precured tire tread abuts a first end of the remaining section of the first precured tire tread.

6. The method of claim 5, wherein the first circumference of the first tire casing is equal to the second circumference of the second tire casing.

7. The method of claim 5, wherein the first length of the first precured tire tread is equal to the second length of the second precured tire tread.

8. The method of claim 5, wherein the second precured tire tread has the first pitch size at the first end and the second pitch size at the second end.

9. The method of claim 5, further comprising cutting at least one additional full section from the second precured tire tread, the at least one additional full section having a length equal to the second circumference of the second tire casing.

10. A precured tire tread comprising:
a first end and a second end, defining a length greater than 10 feet (300 cm); and
a top surface having a plurality of tread elements thereon, the plurality of tread elements defining a tread pattern with a pitch sequence of at least two sizes, including primary pitches having a first pitch size and secondary pitches having a second pitch size,
wherein the pitch sequence includes a pattern of primary pitches and secondary pitches that is repeated at least once along the length of the precured tire tread, and
wherein the precured tire tread has the first pitch size at the first end and the second pitch size at the second end.

11. The precured tire tread of claim 10, wherein a ratio of the first pitch size to the second pitch size is between 1.35 and 1.45.

12. The precured tire tread of claim 10, wherein a ratio of the second pitch size to the first pitch size is between 1.35 and 1.45.

13. The precured tire tread of claim 10, wherein the length of the precured tire tread is greater than 30 feet (900 cm).

14. The precured tire tread of claim 10,
wherein the pitch sequence of primary pitches and secondary pitches has a pattern length,
wherein the primary pitches define 40-60% of the pattern length, and
wherein the secondary pitches define 40-60% of the pattern length.

15. The precured tire tread of claim 10, wherein the pitch sequence of primary pitches and secondary pitches includes no more than four consecutive primary pitches and no more than four consecutive secondary pitches.

16. A method of making a precured tire tread, the method comprising:
providing a tire casing having a tire casing circumference;
providing a first precured tire tread segment having a first end and a second end,
wherein the first precured tire tread segment has a first length less than the tire casing circumference, and
wherein the first precured tire tread segment has a tread pattern with a pitch sequence of at least two sizes, including a first pitch size and a second pitch size;
providing a second precured tire tread segment having a first end and a second end,
wherein the second precured tire tread segment has a second length less than the tire casing circumference,
wherein the first length and the second length are equal to the tire casing circumference, and
wherein the second precured tire tread segment has a tread pattern with a pitch sequence of at least two sizes, including the first pitch size and the second pitch size.

17. The method of claim 16, wherein the first precured tire tread segment has the second pitch size at the second end, and wherein the second precured tire tread segment has the first pitch size at the first end.

18. The method of claim 16, further comprising cutting the first precured tire tread segment from a first precured tire tread, and cutting the second precured tire tread segment from a second precured tire tread.

19. The method of claim 18, wherein the first precured tire tread and the second precured tire tread have identical tread patterns.

20. The method of claim 16, wherein the first precured tire tread and the second precured tire tread have equal lengths.
